(19) United States
(12) Patent Application Publication
(10) Pub. No.: US 2020/0158063 A1
(43) Pub. Date: May 21, 2020

(54) FLUID PULSATION ATTENUATING ARRANGEMENT

(71) Applicant: Hamilton Sundstrand Corporation, Charlotte, NC (US)

(72) Inventor: James S. Elder, South Windsor, CT (US)

(21) Appl. No.: 16/192,412

(22) Filed: Nov. 15, 2018

(51) Int. Cl. F02M 55/04; F04B 11/00; F16L 55/04; F16L 55/02

(52) U.S. Cl. CPC F02M 55/04; F16L 55/02; F16L 55/041; F04B 11/0091

(57) ABSTRACT

A fluid pulsation attenuating arrangement includes an enclosure and a tubular member. The tubular member extends through the enclosure defining a chamber outside of the tubular member but inside of the enclosure. The tubular member includes a wall separating an interior passage of the tubular member and the chamber. A plurality of holes is formed in the wall and fluidically connects the chamber to the interior passage. An energy absorber is inside the chamber.

### BACKGROUND

The present disclosure relates to fluid and lubrication systems, and more specifically to the attenuation of pressure pulses caused by pumps in fluid and lubrication systems.

Many aircraft engine fuel and lubrication systems include gear pumps to circulate fuel and oil. A gear pump can create pressure pulses that travel upstream of a pump inlet, with the amplitude and frequency of the pulses related to the number of gear teeth and rotation speed of the gear pump. In some cases these pressure pulses can be of the same order or even greater than the fluid inlet pressure. When the pressure pulses match or exceed the fluid inlet pressure, these pressure pulses can cause cavitation, wear, and fatigue in housings and lines in the system. Pressure pulses can also adversely impact pressure sensor readings.

### SUMMARY

In one aspect of the disclosure, a fluid pulsation attenuating arrangement includes an enclosure and a tubular member. The tubular member extends through the enclosure defining a chamber outside of the tubular member but inside of the enclosure. The tubular member includes a wall separating an interior passage of the tubular member and the chamber. A plurality of holes is formed in the wall and fluidically connects the chamber to the interior passage. An energy absorber is inside the chamber.

In another aspect of the disclosure, a fluid pulsation attenuator includes a pressure vessel enclosing a chamber and a fluid line extending through the pressure vessel. A plurality of holes is formed in the fluid line inside the pressure vessel. The plurality of holes fluidically connects the chamber and an interior passage of the fluid line. The fluid pulsation attenuator further includes a plurality of fibers inside the chamber. The plurality of fibers fills the chamber and surrounds the fluid line.

In another aspect of the disclosure, a fluid system includes a pump and a fluid pulsation attenuator fluidically connected to the pump. The fluid pulsation attenuator comprises a pressure vessel enclosing a chamber and a fluid line extending through the pressure vessel. A plurality of openings is formed in the fluid line inside the pressure vessel. The plurality of openings fluidically connects the chamber and an interior passage of the fluid line. The fluid pulsation attenuator also includes a cushion inside the chamber.

Persons of ordinary skill in the art will recognize that other aspects and embodiments of the present invention are possible in view of the entirety of the present disclosure, including the accompanying figures.

### BRIEF DESCRIPTION OF THE DRAWINGS

FIG. 1 is a cross-sectional view of an embodiment of a fluid pulsation attenuator.

FIG. 2 is a schematic diagram of a fluid system that comprises the fluid pulsation attenuator of FIG. 1 and a gear pump.

FIG. 3 is a schematic diagram of another fluid system that comprises the fluid pulsation attenuator of FIG. 1 and a gear pump.

FIG. 4 is a cross-sectional view of another embodiment of the fluid pulsation attenuator.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals identify similar structural elements.

### DETAILED DESCRIPTION

The present disclosure provides a fluid pulsation attenuator that attenuates fluid pulsations caused by pumps. The fluid pulsation attenuator includes a pressure vessel enclosing a chamber and a fluid line extending through the pressure vessel and the chamber. Holes are formed in the fluid line inside the pressure vessel and the chamber is filled with a cushion. During operation, fluid flows through the fluid line and any pulsations in the fluid line can expand radially into the holes and be absorbed by the cushion. By absorbing the pulsations in the fluid, the fluid pulse attenuator reduces fatigue to lines and housings in a fluid system that incorporates the fluid pulse attenuator. This reduction in fatigue allows the lines and housings in the fluid system to be made from lighter and thinner structures. Furthermore, the attenuation of the pulsations by the fluid pulsation attenuator allows for more accurate sensor readings of the fluid. The fluid pulsation attenuator is described and discussed below with reference to the figures.

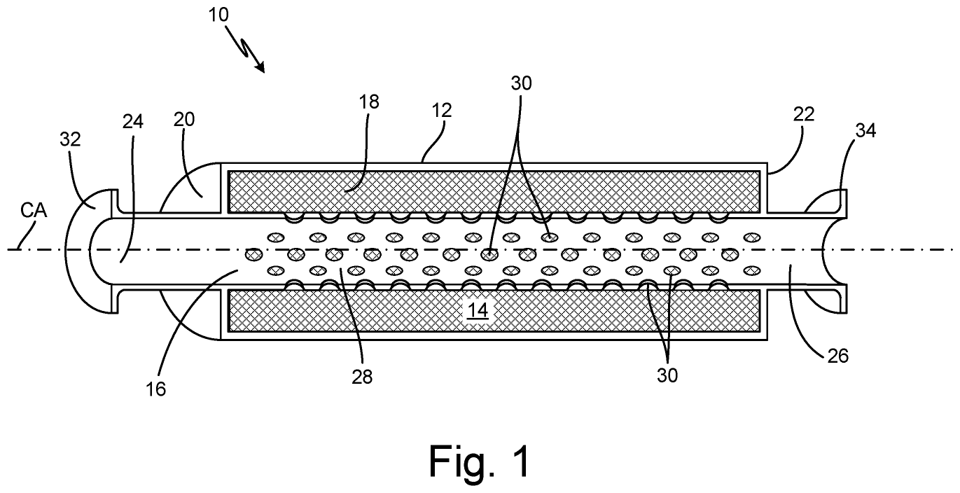

FIG. 1 is a cross-sectional view of fluid pulsation attenuator 10. As shown in FIG. 1, fluid pulsation attenuator 10 includes pressure vessel 12, chamber 14, fluid line 16, cushion 18, and center axis CA. Pressure vessel 12 includes first end 20 and second end 22. Fluid line 16 includes inlet 24, outlet 26, interior passage 28, a plurality of holes 30, first flange 32, and second flange 34.

Pressure vessel 12 is a case or container that encloses chamber 14. As shown in FIG. 1, pressure vessel 12 is an elongated cylinder that extends from first end 20 to second end 22 on center axis CA. While first end 20 and second end 22 are shown as flat in FIG. 1, other embodiments of pressure vessel 12 can include first end 20 and second end 22 that are hemispherical. Fluid line 16 is a tube that extends through an entire length of pressure vessel 12 and extends beyond first end 20 and second 22 of pressure vessel 12. Fluid line 16 is coaxial with pressure vessel 12. Inlet 24 of fluid line 16 extends axially outward from first end 20 of pressure vessel 12. Outlet 26 extends axially outward from second end 22 of pressure vessel 12 opposite inlet 24. In the embodiment of FIG. 1, inlet 24 is the only inlet into pressure vessel 12 and outlet 26 is the only outlet exiting pressure vessel 12. First flange 32 is formed around inlet 24 and second flange 34 is formed around outlet 26. First flange 32 and second flange 34 can be used to connect fluid pulsation attenuator 10 into a fluid system. Pressure vessel 12 and fluid line 16 can be integral, or can be assembled together, and can both be formed from the same material, such as plastic, stainless steel or any other material that non-corrosive when exposed to aircraft engine fuel or lubricant and that can withstand the pressures of a gas turbine engine fuel system or lubrication system.

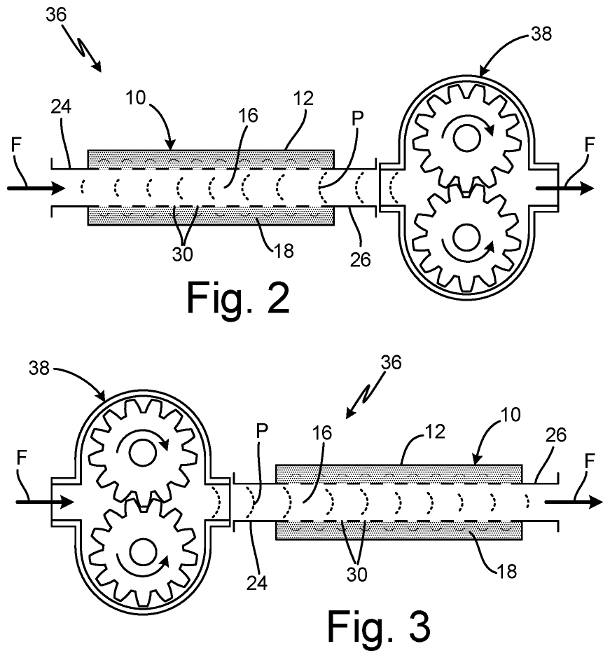

The plurality of holes 30 are formed in a portion of fluid line 16 inside pressure vessel 12. The plurality of holes 30 fluidically connect chamber 14 and interior passage 28 of fluid line 16. As shown in FIG. 1, the plurality of holes 30 is distributed along the length of the portion of fluid line 16 inside pressure vessel 12 between first end 20 and second end 22. Cushion 18 is disposed inside chamber 14. Cushion 18 can be a pad or mass of glass fibers that fills chamber 14 and surrounds the portion of fluid line 16 inside chamber 14. Cushion 18 can also be made from any other material that is chemically and thermally resistant to the fluid intended to flow through fluid pulsation attenuator 10 and capable of absorbing pulsations in the fluid. For example, cushion 18 can also be formed from metal wools. As discussed in greater detail below with reference to FIGS. 2 and 3, fluid pulsation attenuator 10 can be used to attenuate pulsations created by a pump fluidically connected to fluid pulsation attenuator 10.

FIG. 2 is a schematic diagram of fluid system 36 that includes fluid pulsation attenuator 10 and gear pump 38. In the embodiment of FIG. 2, fluid pulsation attenuator 10 is connected directly upstream from gear pump 38 such that outlet 26 of fluid pulsation attenuator 10 empties directly into an inlet of gear pump 38. During operation of fluid system 36, gear pump 38 pulls fluid F such that fluid F flows into inlet 24, through fluid line 16, through outlet 26 and then into gear pump 38. Fluid F can be aircraft fuel or lubricating oil. As fluid F flows through fluid line 16, a portion of fluid F can pass through the plurality of holes 30 in fluid line 16 and enter chamber 14 inside pressure vessel 12.

Gear pump 38 circulates fluid F through fluid system 36 incrementally as the gears in gear pump 38 rotate. Because gear pump 38 circulates fluid F incrementally, gear pump 38 can cause pulsations P to occur in fluid F upstream of gear pump 38. As pulsations P travel upstream, pulsations P enter outlet 26 of fluid pulsation attenuator 10. As pulsations P enter pressure vessel 12, pulsations P are able to expand radially through the plurality of holes 30 in fluid line 16 and interact with cushion 18. The fibers of cushion 18 absorb and dissipate the energy of pulsations P, thereby reducing the amplitude of pulsations P as pulsations P travel upstream through fluid pulsation attenuator 10. When reaching inlet 24, the amplitude pulsations P is so reduced that pulsations P have completely dissipated, or dissipated to such a degree that pulsations P are unable to cause any damage or interference in fluid system 36.

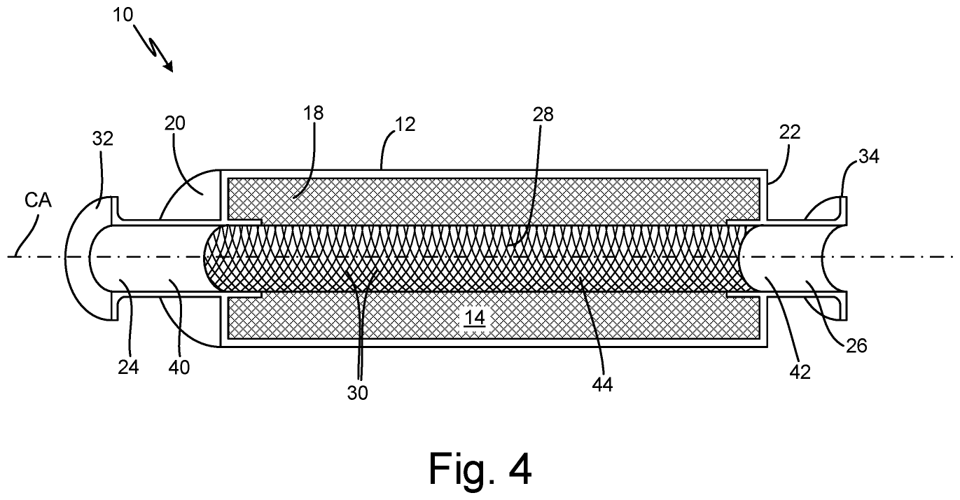

FIG. 3 is a schematic diagram of another embodiment of fluid system 36 that includes fluid pulsation attenuator 10 and gear pump 38. The embodiment of fluid system 36 in FIG. 3 is similar to the embodiment of FIG. 4, except that fluid pulsation attenuator 10 is positioned fluidically downstream to gear pump 38. In the embodiment of FIG. 4, fluid pulsation attenuator 10 attenuates pulsations P created by gear pump 38 in fluid F downstream of gear pump 38. In other embodiments (not shown) of fluid system 36, a first fluid pulsation attenuator 10 can be positioned upstream of gear pump 38 and a second fluid pulsation attenuator 10 can be positioned downstream of gear pump 38.

FIG. 4 is a cross-sectional view of another embodiment of fluid pulsation attenuator 10. As shown in FIG. 4, fluid line 16 of fluid pulsation attenuator 10 includes first solid tube 40, second solid tube 42, and mesh tube 44 with holes 30. First solid tube 40 extends into first end 20 of pressure vessel 12 and into chamber 14. First solid tube 40 forms inlet 24 of fluid line 16. Second solid tube 42 extends into second end 22 of pressure vessel 12 and into chamber 14. Second solid tube 42 forms outlet 26 of fluid line 16. Mesh tube 44 is disposed inside pressure vessel 12 and traverses chamber 14 and is connected between first solid tube 40 and second solid tube 42. Mesh tube 44 can be formed from a metal mesh or screen with holes 30 extending radially through mesh tube 44. Cushion 18 fills chamber 14 and surrounds mesh tube 44. The embodiment of fluid pulsation attenuator 10 shown in FIG. 4 functions similarly to the embodiment described above with reference to FIGS. 1-3.

In view of the foregoing description, it will be recognized that the present disclosure provides numerous advantages and benefits. For example, the present disclosure provides fluid pulsation attenuator 10 that attenuates pulsations P in fluid F caused by gear pump 38. Fluid pulsation attenuator 10 includes pressure vessel 12 encloses chamber 14 and fluid line 16 extends through pressure vessel 12 and chamber 14. Holes 30 are formed in fluid line 16 inside pressure vessel 12 and chamber 14 is filled by cushion 18. During operation, fluid F flows through fluid line 16 and any pulsations P in fluid line 16 can expand radially into holes 30 and be absorbed by cushion 18. By absorbing pulsations P in fluid F, fluid pulse attenuator 10 reduces fatigue to lines and housings in fluid system 36 that incorporates fluid pulse attenuator 10. This reduction in fatigue allows the lines and housings in fluid system 36 to be made from lighter and thinner structures. Furthermore, the attenuation of pulsations P in fluid F by fluid pulsation attenuator 10 allows for more accurate sensor readings of fluid F.

The following are non-exclusive descriptions of possible embodiments of the present invention.

In one embodiment, a fluid pulsation attenuating arrangement includes an enclosure and a tubular member. The tubular member extends through the enclosure defining a chamber outside of the tubular member but inside of the enclosure. The tubular member includes a wall separating an interior passage of the tubular member and the chamber. A plurality of holes is formed in the wall and fluidically connects the chamber to the interior passage. An energy absorber is inside the chamber.

The arrangement of the preceding paragraph can optionally include, additionally and/or alternatively, any one or more of the following features, configurations and/or additional components:

the cushion comprises a pad of fibers that fills the chamber and surrounds the wall;

at least one hole of the plurality of holes extends radially through the wall;

the enclosure is cylindrical and the tubular member is coaxial with the enclosure;

the tubular member further comprises: an inlet extending axially outward from the enclosure; and an outlet extending axially outward from the enclosure in a direction that is opposite the inlet; and/or

the tubular member comprises: a first solid tube extending into the enclosure and forming the inlet of the tubular member; a second solid tube extending into the enclosure and forming the outlet of the tubular member; and a mesh tube inside the enclosure and connected between the first solid tube and the second solid tube.

In another embodiment, a fluid pulsation attenuator includes a pressure vessel enclosing a chamber and a fluid line extending through the pressure vessel. A plurality of holes is formed in the fluid line inside the pressure vessel. The plurality of holes fluidically connects the chamber and an interior passage of the fluid line. The fluid pulsation attenuator further includes a plurality of fibers inside the chamber. The plurality of fibers fills the chamber and surrounds the fluid line.

The fluid pulsation attenuator of the preceding paragraph can optionally include, additionally and/or alternatively, any one or more of the following features, configurations and/or additional components:

the plurality of fibers comprises glass fibers;

the pressure vessel is elongated along a center axis and the fluid line is coaxial with the pressure vessel;

the fluid line comprises: an inlet extending axially from a first end of the pressure vessel; and an outlet extending axially from a second end of the pressure vessel opposite the inlet;

the plurality of holes is distributed on the fluid line inside the pressure vessel from the first end of the pressure vessel to the second end of the pressure vessel; and/or

the fluid line comprises: a first solid tube extending into the pressure vessel and forming the inlet of the fluid line; a second solid tube extending into the pressure vessel and forming the outlet of the fluid line; and a mesh tube inside the pressure vessel and connected between the first solid tube and the second solid tube.

In another embodiment, a fluid system includes a pump and a fluid pulsation attenuator fluidically connected to the pump. The fluid pulsation attenuator comprises a pressure vessel enclosing a chamber and a fluid line extending through the pressure vessel. A plurality of openings is formed in the fluid line inside the pressure vessel. The plurality of openings fluidically connects the chamber and an interior passage of the fluid line. The fluid pulsation attenuator also includes a cushion inside the chamber.

The fluid system of the preceding paragraph can optionally include, additionally and/or alternatively, any one or more of the following features, configurations and/or additional components:

the fluid pulsation attenuator is upstream from the pump;

the fluid pulsation attenuator is downstream from the pump;

the cushion is a pad that comprises fibers;

the pad fills the chamber and surrounds the fluid line;

the fibers comprise glass fibers;

the fluid line comprises: an inlet extending outward from the pressure vessel; and

an outlet extending outward from the pressure vessel opposite the inlet; and/or

the fluid line comprises: a first solid tube extending into the pressure vessel and forming the inlet of the fluid line; a second solid tube extending into the pressure vessel and forming the outlet of the fluid line; and a mesh tube inside the pressure vessel and connected between the first solid tube and the second solid tube.

Any relative terms or terms of degree used herein, such as “substantially”, “essentially”, “generally”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transitory vibrations and sway movements, temporary alignment or shape variations induced by operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, while FIGS. 1-4 disclose pressure vessel 12 as cylindrical, pressure vessel 12 can be spherical or any other geometry capable of withstanding the fluid pressures created by gear pump 38. Therefore, it is intended that the invention not be limited to the particular embodiment(s) disclosed, but that the invention will include all embodiments falling within the scope of the appended claims.

1. A fluid pulsation attenuating arrangement comprising:
an enclosure;
a tubular member extending through the enclosure defining a chamber outside of the tubular member but inside of the enclosure, wherein the tubular member comprises:
a wall separating an interior passage of the tubular member and the chamber; and
a plurality of holes formed in the wall fluidically connecting the chamber to the interior passage; and
an energy absorber inside the chamber.

2. The arrangement of claim 1, wherein the cushion comprises a pad of fibers that fills the chamber and surrounds the wall.

3. The arrangement of claim 1, wherein at least one hole of the plurality of holes extends radially through the wall.

4. The arrangement of claim 1, wherein the enclosure is cylindrical and the tubular member is coaxial with the enclosure.

5. The arrangement of claim 4, wherein the tubular member further comprises:
an inlet extending axially outward from the enclosure; and
an outlet extending axially outward from the enclosure in a direction that is opposite the inlet.

6. The arrangement of claim 5, wherein the tubular member comprises:
a first solid tube extending into the enclosure and forming the inlet of the tubular member;
a second solid tube extending into the enclosure and forming the outlet of the tubular member; and
a mesh tube inside the enclosure and connected between the first solid tube and the second solid tube.

7. A fluid pulsation attenuator comprising:
a pressure vessel enclosing a chamber;
a fluid line extending through the pressure vessel;
a plurality of holes formed in the fluid line inside the pressure vessel, wherein the plurality of holes fluidically connects the chamber and an interior passage of the fluid line; and
a plurality of fibers inside the chamber, wherein the plurality of fibers fills the chamber and surrounds the fluid line.

8. The fluid pulsation attenuator of claim 7, wherein the plurality of fibers comprises glass fibers.

9. The fluid pulsation attenuator of claim 7, wherein the pressure vessel is elongated along a center axis and the fluid line is coaxial with the pressure vessel.

10. The fluid pulsation attenuator of claim 9, wherein the fluid line comprises:
an inlet extending axially from a first end of the pressure vessel; and
an outlet extending axially from a second end of the pressure vessel opposite the inlet.

11. The fluid pulsation attenuator of claim 10, wherein the plurality of holes is distributed on the fluid line inside the pressure vessel from the first end of the pressure vessel to the second end of the pressure vessel.

12. The fluid pulsation attenuator of claim 10, wherein the fluid line comprises:
a first solid tube extending into the pressure vessel and forming the inlet of the fluid line;
a second solid tube extending into the pressure vessel and forming the outlet of the fluid line; and
a mesh tube inside the pressure vessel and connected between the first solid tube and the second solid tube.

13. A fluid system comprising:
a pump; and
a fluid pulsation attenuator fluidically connected to the pump, wherein the fluid pulsation attenuator comprises:
a pressure vessel enclosing a chamber;
a fluid line extending through the pressure vessel;
a plurality of openings formed in the fluid line inside the pressure vessel, wherein the plurality of openings fluidically connects the chamber and an interior passage of the fluid line; and
a cushion inside the chamber.

14. The system of claim 13, wherein the fluid pulsation attenuator is upstream from the pump.

15. The system of claim 13, wherein the fluid pulsation attenuator is downstream from the pump.

16. The system of claim 13, wherein the cushion is a pad that comprises fibers.

17. The system of claim 16, wherein the pad fills the chamber and surrounds the fluid line.

18. The system of claim 17, wherein the fibers comprise glass fibers.

19. The system of claim 13, wherein the fluid line comprises:
an inlet extending outward from the pressure vessel; and
an outlet extending outward from the pressure vessel opposite the inlet.

20. The system of claim 19, wherein the fluid line comprises:
a first solid tube extending into the pressure vessel and forming the inlet of the fluid line;
a second solid tube extending into the pressure vessel and forming the outlet of the fluid line; and
a mesh tube inside the pressure vessel and connected between the first solid tube and the second solid tube.
